(19) United States
(12) Patent Application Publication
(10) Pub. No.: US 2007/0143856 A1
(43) Pub. Date: Jun. 21, 2007

(54) Method and apparatus for managing content in a mobile device

(76) Inventors: Naveen Aerrabotu, Gurnee, IL (US); Hosame H. Abu-Amara, Round Lake, IL (US); Balakumar Jagadesan, Glendale Heights, IL (US)

Correspondence Address: ANDERSON CHEN;Min, Hsieh & Hack, LLP, Suite 630, 8270 Greenboro Drive, McLean, VA, 22102, US

(21) Appl. No.: 11/311,942

(22) Filed: Dec. 20, 2005

(51) Int. Cl. H04N 7/16; H04L 9/32; H04L 9/00; G06F 17/30; G06F 7/04; G06K 9/00; H03M 1/68; H04K 1/00

(52) U.S. Cl. 726/26; 726/27; 726/28; 726/29; 713/165; 713/167

(57) ABSTRACT

An embodiment generally relates to a method of managing content in a mobile device. The method includes receiving content from a provider, where the content includes at least one file segmented into plurality of segments and at least one segment being encoded with a digital rights management (DRM) technique. The method also includes determining DRM status each segment of the plurality of segments and retrieving a DRM permission in response to the at least one segment being encoded by a DRM technique. The method further includes applying the DRM permission to the at least one segment of the content and displaying the least one segment.

### FIELD

This invention relates generally to managing data. More particularly, embodiments relate to managing content protected by digital rights management techniques in a communication device.

### DESCRIPTION OF THE RELATED ART

Digital rights management (“DRM”) may be considered an umbrella term that refers to technical methods used to control or restrict the use of digital media content on electronic devices. For example, one technique is forward locking. In forward locking, the digital media is encoded so that when it is downloaded to an electronic device, it cannot be copied from the electronic device. Another technique is combined delivery. This technique involves defining how the content is to be used (or copied). These restrictions are then downloaded with the content to an electronic device. The restrictions then govern how the content is to be used by the user. Yet another technique is separate delivery. In this technique, the content is delivered in an encrypted form separately from a decryption key, which is pushed to the electronic device together with the set of rights. This means that the content can be copied freely, but can't be used unless the user has the decryption key and rights, which will be pushed directly from the content provider to the electronic device.

Typical content from a provider may involve a large amount of data such as a high-resolution image. However, the user may not be interested in viewing the entire content at the highest resolution. A viewer may only be interested in viewing a section of the image at high resolution. Current DRM techniques do not provide a mechanism to control a property of the image.

### SUMMARY

An embodiment generally relates to a method of managing content in a mobile device. The method includes receiving content from a provider, where the content includes at least one file segmented into plurality of segments and at least one segment being encoded with a digital rights management (DRM) technique. The method also includes determining DRM status each segment of the plurality of segments and retrieving a DRM permission in response to the at least one segment being encoded by a DRM technique. The method further includes applying the DRM permission to the at least one segment of the content and displaying the least one segment.

Another embodiment generally pertains to an apparatus for managing content in a mobile device. The apparatus includes a display configured to display image files, a network interface configured to interface with a wireless network and a digital rights management (DRM) module configured to manage digital rights associated with received content. The apparatus also includes a controller configured to interface with the display, network interface, and the DRM module. The controller is also configured to determine a DRM status of received content by using the DRM module and to display the content in response to the DRM status of the received content on the display, where the content comprises at least one file partitioned into plurality of tiles. The controller is further configured to retrieve a DRM permission for at least one tile of the content being encoded by a DRM technique through the network interface and to apply the DRM permission to the at least one tile of the content using the DRM module.

Yet another embodiment generally relates to a method of providing content. The method includes providing content to a plurality of users, where the content comprises of at least one file, and subdividing the at least one file into a plurality of sections. The method also includes applying a digital rights management (DRM) encoding technique to each of the sections and packaging the at least one section encoded with the DRM technique and the unencoded sections of the plurality of sections as the content.

Accordingly, embodiments generally assist users in managing content in a communication device. More particularly, embodiments may display received DRM encoded content at a base resolution. The user may then retrieve the DRM permission to view certain sections of the received content with a different image property. Accordingly, a user may alter the image properties of sections of the received content and thereby permitting greater control of the received content.

### BRIEF DESCRIPTION OF THE DRAWINGS

Various features of the embodiments can be more fully appreciated, as the same become better understood with reference to the following detailed description of the embodiments when considered in connection with the accompanying figures, in which:

FIG. 1 illustrates a block diagram of an exemplary communication device where an embodiment may be practiced;

FIG. 2 illustrates a block diagram of an exemplary system where another embodiment may be practiced;

FIG. 3 illustrates an exemplary DRM structure in accordance with yet another embodiment.

FIG. 4 illustrates a flow diagram implemented by yet another embodiment; and

FIG. 5 illustrates a flow diagram implemented by yet another embodiment.

FIG. 6 illustrates a flow diagram implemented by yet another embodiment.

### DETAILED DESCRIPTION OF EMBODIMENTS

For simplicity and illustrative purposes, the principles of the present invention are described by referring mainly to exemplary embodiments thereof. However, one of ordinary skill in the art would readily recognize that the same principles are equally applicable to, and can be implemented in, all types of wireless communication systems, and that any such variations do not depart from the true spirit and scope of the present invention. Moreover, in the following detailed description, references are made to the accompanying figures, which illustrate specific embodiments. Electrical, mechanical, logical and structural changes may be made to the embodiments without departing from the spirit and scope of the present invention. The following detailed description is, therefore, not to be taken in a limiting sense and the scope of the present invention is defined by the appended claims and their equivalents.

Embodiments generally relate to managing digital rights management (DRM) files on a communication device, e.g., a cellular telephone, a personal digital device or other similar device. More particularly, a content provider may provide DRM encoded content to users, where the DRM rights may be applied to sections of the original content, e.g., an image file. For example, the JPEG 2000 provides for breaking up a file into multiple sections (or partitions, segments, tiles, etc). These sections may be encoded the same or encoded so that one section differs from another according to the JPEG 2000 specification. Moreover, these sections may also be further encoded with other DRM techniques or other cryptographic techniques such as public/private key pairs.

In some embodiments, the content provider may partition a file into multiple tiles. The content provider may provide alternate tiles for each tile. The alternate tiles may be encoded with DRM and/or cryptographic techniques. The content provider may then add information to the metadata associated with each tile, where the information includes a linkage or reference (indirectly or directly) to the associated alternate tiles. Accordingly, the content provider may package the multiple tiles with the alternate tiles as the content for a user. When the user displays the content, the alternate tiles may be displayed instead of the associated tile because of the reference data in the metadata. Alternatively, the content provider may package the multiple tiles replaced with the alternative tiles as the content.

The metadata may also be configured to include identifier data to associate with a respective DRM permission or key. The identifier data may be used by the user to request the appropriate DRM permission. In other embodiments, the metadata may include the DRM permission with the content. The content provider may then receive payment information and related information from the user while the user has instant access to the DRM encoded tiles.

Yet another embodiment relates to a method of a mobile device receiving content from a provider. The mobile device executing an associated application for the received content may display the content according to the DRM permissions. For example, a small number of sections of the content may not be DRM encoded while other sections may be DRM encoded. Thus, the mobile device may display the non-DRM encoded sections while blocking or obscuring the DRM encoded sections. For the DRM encoded sections, user may optionally invoke the mobile device to retrieve the DRM permissions and decode the DRM encoded sections of the content.

In another embodiment, a communication device may be configured to receive content from a provider. The communication device may determine whether the content is DRM protected. If the content is not protected, the communication device may decode the received content. Otherwise, the communication device retrieves the DRM permission the sender has set for the received content. The communication device is then configured to decode the picture at the base resolution. The communication device may then determine from the received DRM permissions the next course of action. For example, the sender may have set the DRM rights for the receiver to view only certain sections of the file. In other instances, the sender may have set the DRM rights for the receiver to display the received content with better image properties (e.g., resolution, brightness, etc.)

In yet another embodiment, a mobile device may be configured to receive content from a content provider. The content may be a single file that the content provider divided into segments (or sections, portions, parts, tiles, etc.) The content provider may choose not to DRM encode certain segments while other segments may be DRM encoded. Some of the segments can be replaced with alternate segments that are DRM protected. If the user of the device wishes to use the alternate DRM protected segments, then the device retrieves the DRM permission from the sender. To speed up retrieval of DRM permission, the DRM permission may be bundled with the content, so that the device can immediately access the permission while simultaneously providing information, such as payment information, to the content provider.

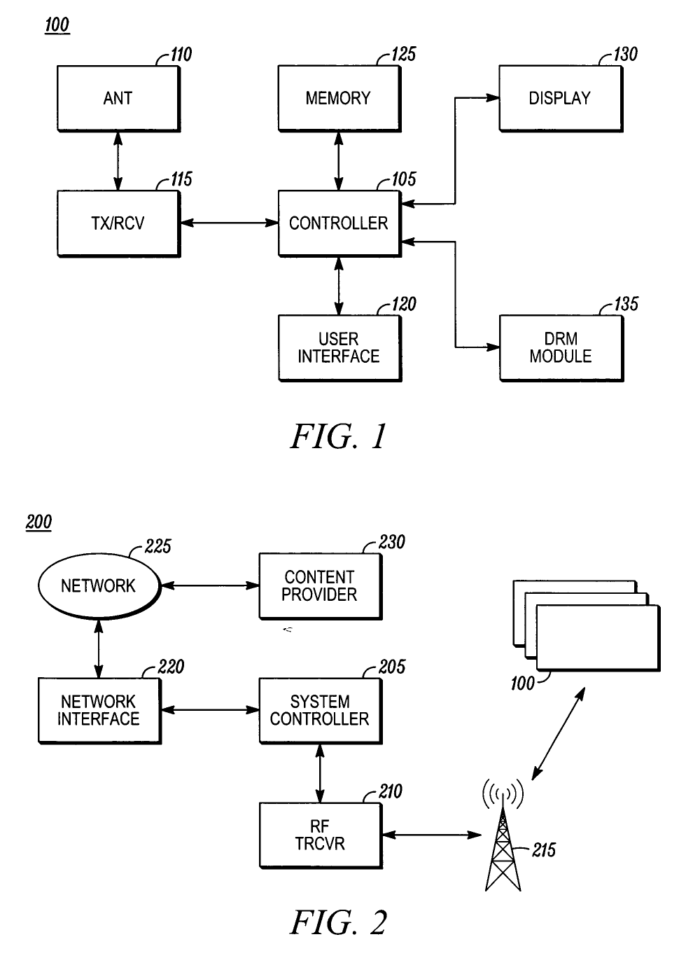

FIG. 1 illustrates a block diagram of an exemplary communication device 100 where an embodiment may be practiced. It should be readily apparent to those of ordinary skill in the art that the communication device 100 depicted in FIG. 1 represents a generalized schematic illustration and that other components may be added or existing components may be removed or modified. Moreover, the communication device 100 may be implemented using software components, hardware components, or combinations thereof.

As shown in FIG. 1, the communication device 100 includes a controller 105, an antenna 110 (labeled as “ANT”), a transceiver 115 (labeled as “TX/RCV”), a user interface module 120, a memory 125, a display module 130 and a digital rights management module 135 (labeled as “DRM module”).

Although FIG. 1 depicts a communication device 100 as a specific device, it should be readily apparent to those of ordinary skill in the art that the communication device may be any device that can communicate with other devices using wireless communication such as radio frequency, infrared, wireless signals over a network or other similar techniques. In certain embodiments, the communication device may be implemented a cellular telephone, a personal digital assistant (“PDA”), laptop computers and other similar portable computing devices.

Returning to FIG. 1, the controller 105 may be configured to provide the functionality of the communication device 100. More particularly, the controller 105 may execute an operating system and/or software programs that provide the functionality for the communication device 100. The controller 105 may be implemented using a microprocessor, a digital signal processor, application specific integrated circuit or other similar computing platform.

The controller 105 may also be configured to interface with the transceiver 115. The transceiver 115 may be configured to convert data (e.g., voice, video, audio, etc) between a wireless protocol and the native format of the controller 105. The wireless protocol may be implemented using Wireless Personal Area Networks (e.g., Bluetooth, HomeRF, IEEE 802.15.3 protocols or other similar protocols), Wireless Local Area Networks (e.g., Hiperlan 2, IEEE 802.11 x, or other similar protocols), WiFi, Cellular Digital Packet Data, Mobitex, Wireless Application Protocol, Global System for Mobiles, or other similar wireless protocol for communicating audio, voice, data and/or video.

The transceiver 115 may be configured to interface with the antenna 110. The antenna 110 may be configured to provide a communication channel between the communication device 100 and a service provider. More particular, the antenna 110 may be configured to receive and transmit radio frequency signals. The service provider may be a cellular telephone provider, a WIFI hotspot, an ad hoc network or other similar network.

The controller 105 may be further configured to interface with the user interface 120. The user interface 120 may be configured to provide a mechanism for a user of the communication device 100 to interact thereof. In some embodiments, the user interface 120 may be Bell keypad or a QWERTY keyboard. In other embodiments, the user interface 120 may be integrated with the display 120. More particularly, the display 120 may be a touch screen where the controller 105 executes software that permits a user to interact with the communication device 100 using a stylus or other similar device.

The controller 105 may be further configured to interface the memory 125. The memory 125 may be configured to store the operating system, application software programs and data entered by the user. The memory 125 may be implemented using persistent memory (e.g., flash memory, EEPROM, etc), non-persistent memory (e.g., RAM) or combinations thereof.

The display 130 may be configured to interface with the controller 105. The display 130 may also be configured to provide a visual interface for the operation of the communication device 100. The display 130 may be implemented using a liquid crystal display matrix, a thin film transistor array or a similar display technology.

The controller 105 may be further configured to interface with the DRM module 135. The DRM module 135 may be configured to provide DRM services for the communication device 100. For example, the DRM module 135 may be configured to determine whether any received content is DRM protected. The DRM module 135 may also be configured to maintain a database of DRM permissions (or licenses) for content received by the communication device 100.

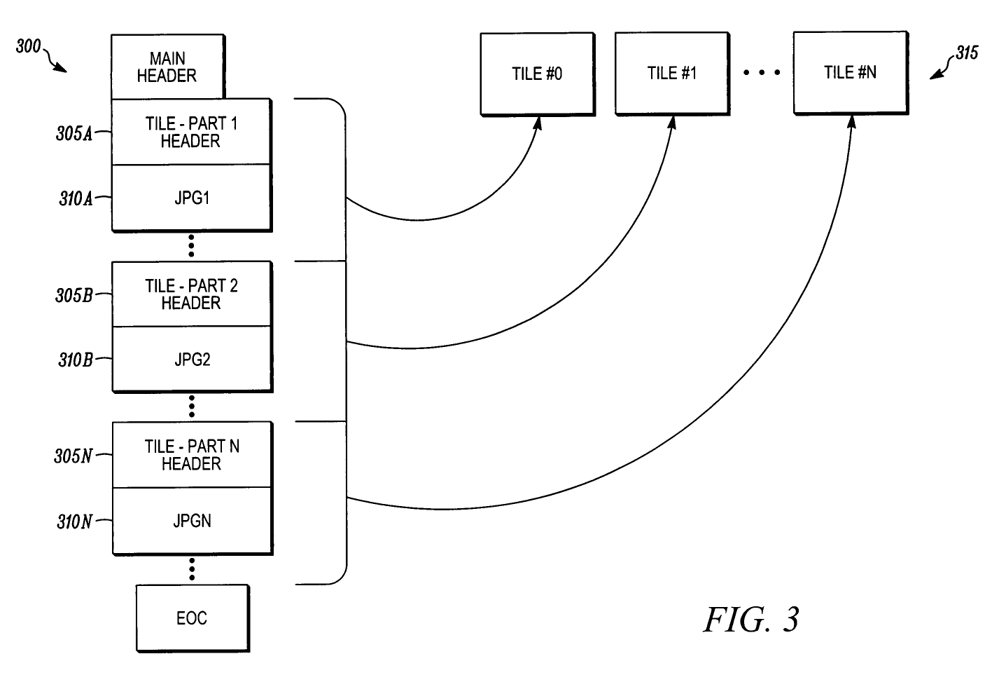

FIG. 2 illustrates a system 200 where another embodiment may be practiced. It should be readily apparent to those of ordinary skill in the art that the system 200 depicted in FIG. 2 represents a generalized schematic illustration and that other components may be added or existing components may be removed or modified. Moreover, the system 200 may be implemented using software components, hardware components, or combinations thereof.

As shown in FIG. 2, the system 200 includes a system controller 205, a RF transceiver 210 (“labeled RF TRCVR”), antennas 215, and a network interface 220. The system controller 205 may be configured to interface with the RF transceiver 210 to communicate with the communication devices 100. The system controller 205 may function utilizing any wireless RF channel, for example, a one- or two-way pager channel, a mobile cellular channel, or a mobile radio channel.

The system controller 205 may include a subscriber database (not shown). The subscriber database provides information related to the communication device 100 as the communication device 100 enters the cell site of the antenna 215. The system controller 205 may also be configured to interface with a network interface 225. The network interface 225 may be configured to provide a communication channel to a network 225. The network 225 may be a public switch telephone network, local area networks, wide area networks (such as the Internet) or a combination thereof.

The system controller 205 may be further configured to interface with a content provider 230. The content provider 230 may be configured to provide content and/or services for the communication device 100. For example, the communication device 100 may be an Internet capable device. As such, the content provider 230 may be the information portal to the Internet for the communication device 100. As another example, the content provider may also provide DRM protected content to the communication device 100. The content provider 230 may be further configured to provide DRM licenses for those users requesting the same. This may be implemented using a message-based system.

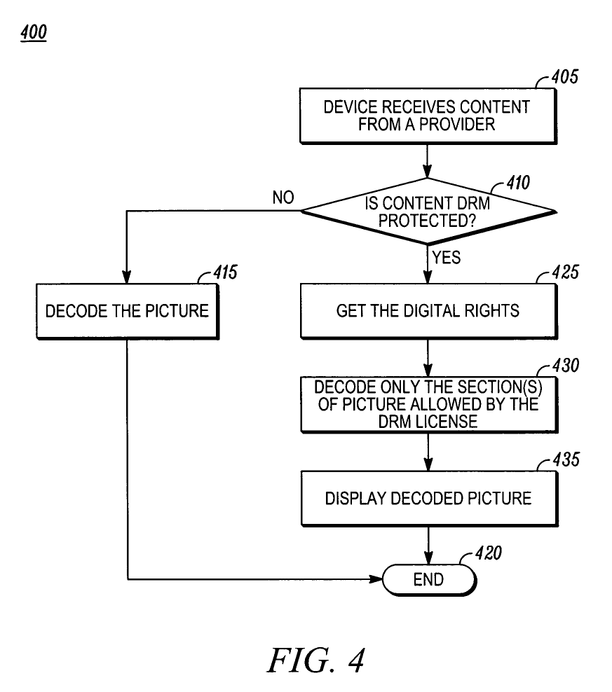

FIG. 3 illustrates an exemplary structure of content in accordance with yet another embodiment. As shown in FIG. 3, the content may be an image file 300 in the JPEG 2000 format. Accordingly to the JPEG 2000 specification, an image file may be partitioned into tiles (sections, segments or portions) 300A-N. Each tile may also be encoded individually and packaged as header 305A-N and associated image data 310A-N. The information contained in the header (or metadata) may be used to identify the section of the file that a permission may be requested for, i.e., identifier information or data. For example, tile 300A may be encoded with a different. resolution than tile 300B. When the associated keys (licenses or permissions) are applied to the respective tiles from the identifier information of the metadata, the original image may be recreated. In other embodiments, the identifier information of the metadata may include the DRM permission for an encoded DRM tile. Accordingly, the user may have convenient access to the underlying data in the DRM encoded tile without waiting for the request for DRM permission to transact between the user and the content provider.

The identifier information of the metadata may also contain reference (indirectly or directly) to alternate segments. In certain embodiments, the content provider may have created DRM encoded alternate sections for a selected section of a file. The content provider may package the un-coded sections with the alternate sections of the file as the content and forward to the user when requested. Accordingly, a user may select a DRM encoded alternate section of the file when prompted by the user.

In some embodiments, the sections of an image file may be differentially DRM encoded by a content provider. As a result, a user may retrieve a select key for a user-specified tile of the image file because the user may be interested in one section of the image file. The user may retrieve multiple keys for multiple sections of the image file depending on the interest of viewing more sections of the image file.

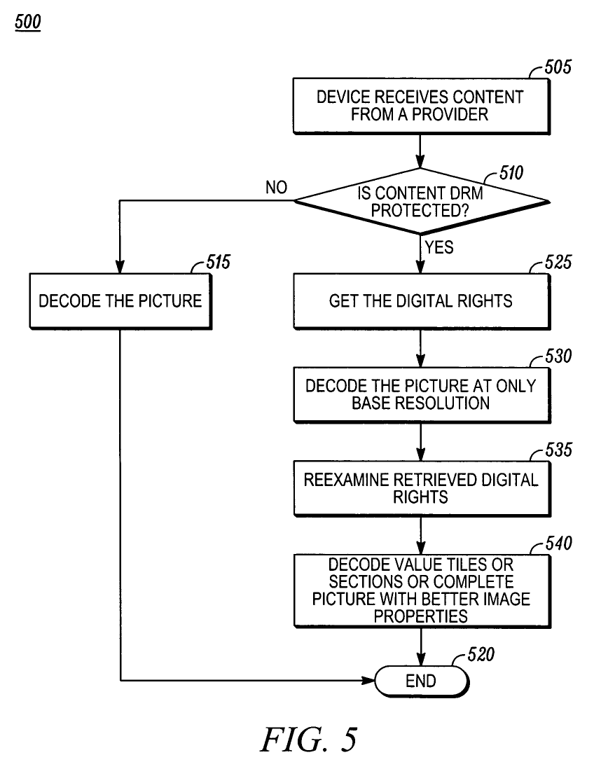

FIG. 4 illustrates a flow diagram 400 implemented by yet another embodiment. It should be readily apparent to those of ordinary skill in the art that the flow diagram 400 depicted in FIG. 4 represents a generalized schematic illustration and that other steps may be added or existing steps may be removed or modified.

As shown in FIG. 4, the controller 105 may be configured to be invoked when content from a content provide arrives through the transceiver 115, in step 405. The controller 105 may temporarily store the received content in the memory 125.

In some embodiments, the functionality embodied in FIG. 4 may be implemented as a computer program application. As a result, the computer program application can be invoked in response to an event, e.g., the arrival of content. In other embodiments, the functionality embodied in FIG. 4 may be implemented on a hardware platform such as an application specific integrated circuit, PROM, etc. For those skilled in the art, a hardware implementation of FIG. 4 may be configured to be in an idle state until invoked by the arrival of content.

In step 410, the controller 105 may be configured to determine whether the received content is DRM protected. More particularly, the controller 105 may be configured to examine the metadata (e.g., the header) associated with the received content. The metadata may contain the data that describes the DRM protections for the content. If the controller 105 determines that the received content is not DRM protected or the user already has permission for the received content, the controller 105 may display the received content on the display 105, in step 415. Subsequently, in step 420, the controller 105 may terminate processing and return to an idle state.

Returning to step 410, if the controller 105 determines that the received content is DRM protected, the controller 105 may be configured to retrieve the required DRM licenses (or permissions) associated with the received content, in step 425. For example, the controller 105 may generate a message to the content provider requesting the requisite licenses.

In step 430, the controller 105 may be configured to apply the received DRM permissions from the content provider to the received content stored in memory 125. More particularly, the DRM module 135 may be configured to apply the received DRM permissions to the received content to unlock the received content. In some embodiments, the received content may be encoded with the multiple levels of permissions. For example, a portion of the received content may have multiple permissions. If a user retrieves a first level DRM permission, the portion of the received content may be displayed at a first level resolution or other image property. If a user retrieves another level DRM permission, the portion of the received content may be displayed at a higher level resolution or other image property.

In step 435, the controller 105 may be configured to display the received content. More particularly, the controller 105 may forward the received DRM permissions to the DRM module 135. The DRM module 135 may then apply the DRM permissions to the received content to unlock the additional data associated with the DRM permissions. Subsequently, the controller 105 may go to the processing of step 420.

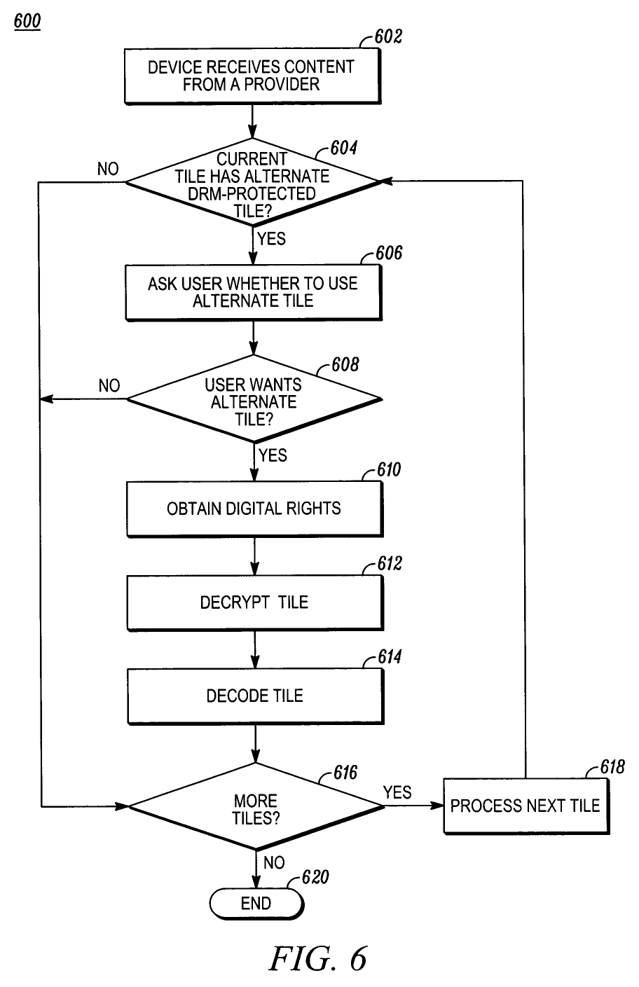

FIG. 5 illustrates a flow diagram 500 implemented by yet another embodiment. It should be readily apparent to those of ordinary skill in the art that the flow diagram 500 depicted in FIG. 5 represents a generalized schematic illustration and that other steps may be added or existing steps may be removed or modified.

As shown in FIG. 5, the controller 105 may be configured to be invoked when content from a content provide arrives through the transceiver 115, in step 505. The controller 105 may temporarily store the received content in the memory 125.

In some embodiments, the functionality embodied in FIG. 5 may be implemented as a computer program application. As a result, the computer program application can be invoked in response to an event, e.g., the arrival of content. In other embodiments, the functionality embodied in FIG. 5 may be implemented on a hardware platform such as an application specific integrated circuit, PROM, etc. For those skilled in the art, a hardware implementation of FIG. 5 may be configured to be in an idle state until invoked by the arrival of content.

In step 510, the controller 105 may be configured to determine whether the received content is DRM protected. More particularly, the controller 105 may be configured to examine the metadata associated with the received content. The metadata may contain the data that describes the DRM protections for the content. If the controller 105 determines that the received content is not DRM protected or the user already has permission for the received content, the controller 105 may display the received content on the display 105, in step 515. Subsequently, in step 520, the controller 105 may terminate processing and return to an idle state.

Returning to step 510, if the controller 105 determines that the received content is DRM protected, the controller 105 may be configured to retrieve the required DRM licenses (or permissions) associated with the DRM encoded portions of the received content, in step 525. For example, the controller 105 may generate a message to the content provider requesting the requisite licenses.

In step 530, the controller 105 may be configured to display at the received content at the resolution available as set by the associated DRM licenses.

In step 535, the controller 105 may be configured to examine the received DRM permissions from the content provider to the received content stored in memory 125. More particularly, the DRM module 135 may be configured to apply the received DRM permissions to the received content to unlock the received content. In some embodiments, the received content may be encoded with the multiple levels of permissions. For example, a portion of the received content may have multiple permissions. If a user retrieves a first level DRM permission, the portion of the received content may be displayed at a first level resolution or other image property. If a user retrieves another level DRM permission, the portion of the received content may be displayed at a higher level resolution or other image property.

In step 540, the controller 105 may be configured to display the received content. More particularly, the controller 105 may forward the received DRM permissions to the DRM module 135. The DRM module 135 may then apply the DRM permissions to the received content to unlock the additional data associated with the DRM permissions. Subsequently, the controller 105 may go to the processing of step 520.

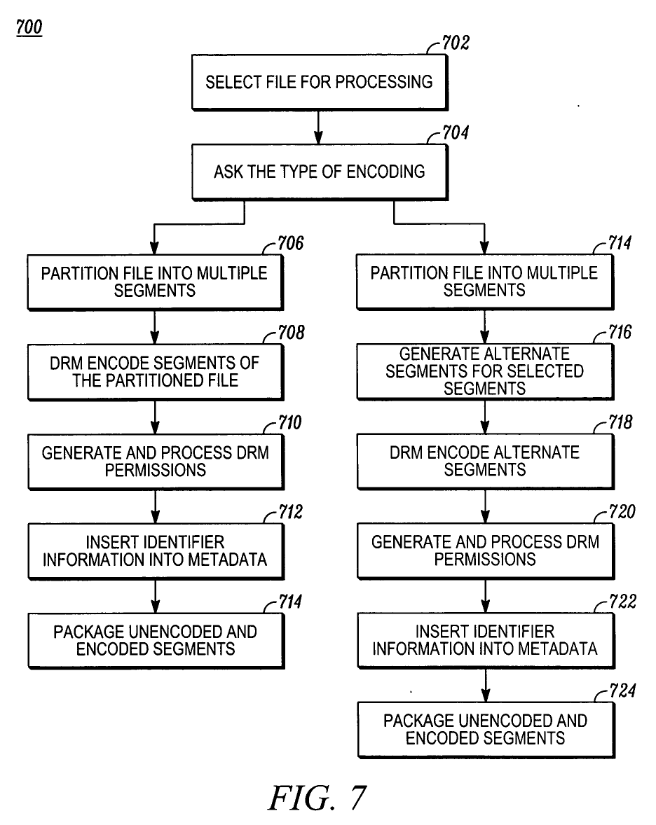

FIG. 6 illustrates a flow diagram 600 implemented by yet another embodiment. It should be readily apparent to those of ordinary skill in the art that the flow diagram 600 depicted in FIG. 6 represents a generalized schematic illustration and that other steps may be added or existing steps may be removed or modified.

As shown in FIG. 6, the controller 105 may be configured to be invoked when content from a content provide arrives through the transceiver 115, in step 602. The controller 105 may temporarily store the received content in the memory 125.

In some embodiments, the functionality embodied in FIG. 6 may be implemented as a computer program application. As a result, the computer program application can be invoked in response to an event, e.g., the arrival of content. In other embodiments, the functionality embodied in FIG. 6 may be implemented on a hardware platform such as an application specific integrated circuit, PROM, etc. For those skilled in the art, a hardware implementation of FIG. 6 may be configured to be in an idle state until invoked by the arrival of content.

In step 604, the controller 105 may be configured to examine a current segment or tile to determine whether the current tile (or segment) can be replaced with an alternate tile (or segment) that is DRM protected. More particularly, the controller 105 may be configured to examine the metadata associated with the received content. The metadata may contain the data that describes alternate segments or tiles associated with the current segment or may describe the DRM protections for the alternate tiles. If the controller 105 determines that the current tile has no alternate tile or the user already has permission for a tile, the controller 105 may display the current tile on the display 105, in step 614. Subsequently, in step 616, the controller 105 determines whether there are additional tiles subsequent to the current tile in the received content. Upon determining that there are such additional tiles, the controller 105 processes each additional tile in order starting with the current tile in step 618 and applies step 604 to each additional tile in order starting with the current.

Returning to step 616, if the controller 105 determines that there are no additional beyond the current tile, the controller 105 may terminate processing and return to an idle state in step 620.

Returning to step 604, if the controller 105 determines that the current tile can be replaced with at least one alternate tile that is DRM protected, the controller 105 may be configured to query the user of the device 100 via display 130 in step 606 as to whether the user wants to use the at least one alternate tile.

In step 608, if the user does not want to use the at least one alternate tile, then the user informs controller 105 via user interface 120 that the user does not want to use the at least one alternate tile. The controller 105 may then display the current tile on the display 105, in step 614.

Returning to step 608, if the user wants to use the at least one alternate tile, then the user informs controller 105 via user interface 120 that the user wants to use the at least one alternate segment or tile. The controller 105 may then retrieve the required DRM licenses (or permissions) associated with the received content, in step 610. For example, the controller 105 may generate a message to the content provider requesting the requisite licenses. Alternatively, to speed up retrieval of DRM permissions, the DRM permission may be bundled with the content in device memory 125, so that the controller 105 can immediately transfer the DRM permission from memory 125 to DRM module 135 while simultaneously generating a message to the content provider providing information, such as payment information. This alternative retrieval method for DRM permission follows the pay-per-view model common in cable systems.

In step 612, the controller 105 may be configured to examine the received DRM permissions from the content provider to the received content stored in memory 125. More particularly, the controller 105 may forward the received DRM permissions to the DRM module 135. The DRM module 135 may be configured to apply the received DRM permissions to the alternate tile to unlock the alternate tile. The controller 105 may replace the current tile with the alternate tile after the DRM module 135 unlocks the alternate tile. Subsequently, the controller 105 may go to the processing of step 614.

FIG. 7 illustrates a flow diagram 700 implemented by yet another embodiment. It should be readily apparent to those of ordinary skill in the art that the flow diagram 700 depicted in FIG. 7 represents a generalized schematic illustration and that other steps may be added or existing steps may be removed or modified.

In some embodiments, the functionality embodied in FIG. 7 may be implemented as a computer program application. In other embodiments, the functionality embodied in FIG. 7 may be implemented on a hardware platform such as an application specific integrated circuit, PROM, etc. For those skilled in the art, a hardware implementation of FIG. 7 may be configured to be in an idle state until invoked by the arrival of a file.

As shown in FIG. 7, a content provider may select a file for processing, in step 702. In some embodiments, a selected file may be an image file. The content provider may be prompted to determine the type of encoding for the selected file, in step 704. This may be implemented as a dialog box with providing the encoding options. Although FIG. 7 depicts two encoding schemes, it should readily obvious that other types of encoding schemes may be implemented without departing from the scope of the claimed inventions.

When the content provider selects an option of embedded DRM encoding, i.e., the content contains un-encoded and DRM-encoded segments (partitions, parts, sections, tiles), the selected file may be partition into multiple segments, in step 706. In some embodiments, the selected file may be segmented according to JPEG2000 specification.

In step 708, the content provider may select the segments of the segmented file to be DRM encoded. The selected segments may be DRM encoded the same, DRM-encoded differently from one another, or some other arrangement. As the segments are encoded, associated DRM permissions (licenses, keys, etc.) may also be generated in step 710. The DRM permissions may be stored with at the content provider with a link to the appropriate DRM permission included in the identifier information for the selected segment, in step 712. In other embodiments, the DRM permission may be included in the identifier information in the metadata for the selected segment. In step 714, the content provider may package the un-encoded and DRM encoded segments as the content for delivery to users (or subscribers).

Returning to step 704, when the content provider selects an alternate segment encoding, the selected file is partitioned into multiple segments, in step 714 (similar to step 706). The user, in step 716, may create a subset of segments from the segmented file. For each segment, one or more alternate segments may be generated.

In step 718, the alternate segments may be DRM encoded the same, DRM-encoded differently from one another, or some other arrangement. As the segments are encoded, associated DRM permissions (licenses, keys, etc.) may also be generated in step 720. The DRM permissions may be stored with at the content provider with a link to the appropriate DRM permission included in the identifier information for the selected segment, in step 722. In other embodiments, the DRM permission may be included in the identifier information in the metadata for the selected segment. In step 724, the content provider may package the un-encoded and DRM encoded alternate segments as the content for delivery to users (or subscribers).

Certain embodiments may be performed as a computer program. The computer program may exist in a variety of forms both active and inactive. For example, the computer program can exist as software program(s) comprised of program instructions in source code, object code, executable code or other formats; firmware program(s); or hardware description language (HDL) files. Any of the above can be embodied on a computer readable medium, which include storage devices and signals, in compressed or uncompressed form. Exemplary computer readable storage devices include conventional computer system RAM (random access memory), ROM (read-only memory), EPROM (erasable, programmable ROM), EEPROM (electrically erasable, programmable ROM), and magnetic or optical disks or tapes. Exemplary computer readable signals, whether modulated using a carrier or not, are signals that a computer system hosting or running the present invention can be configured to access, including signals downloaded through the Internet or other networks. Concrete examples of the foregoing include distribution of executable software program(s) of the computer program on a CD-ROM or via Internet download. In a sense, the Internet itself, as an abstract entity, is a computer readable medium. The same is true of computer networks in general.

While the invention has been described with reference to the exemplary embodiments thereof, those skilled in the art will be able to make various modifications to the described embodiments without departing from the true spirit and scope. The terms and descriptions used herein are set forth by way of illustration only and are not meant as limitations. In particular, although the method has been described by examples, the steps of the method may be performed in a different order than illustrated or simultaneously. Those skilled in the art will recognize that these and other variations are possible within the spirit and scope as defined in the following claims and their equivalents.

1. A method of managing content in a mobile device, the method comprising:
receiving content from a provider, wherein the content comprises at least one file segmented into plurality of segments and at least one segment being encoded with a digital rights management technique;
determining DRM status each segment of the plurality of segments;
retrieving a DRM permission in response to the at least one segment being encoded by a DRM technique;
applying the DRM permission to the at least one segment of the content; and
displaying the least one segment.

2. The method of claim 1, further comprising displaying the segments of the content that are not DRM encoded.

3. The method of claim 1, further comprising segmenting the at least one file according to JPEG20000.

4. The method of claim 3, wherein the content is an image file.

5. The method of claim 1, wherein the at least one segment encoded with the DRM technique includes an identifier.

6. The method of claim 1, further comprising:
forming a message requesting the DRM permission for the respective at least one segment, wherein the message includes the identifier for the at least one segment encoded by the DRM technique; and
transmitting the message over a network, wherein the network includes a wireless portion.

7. The method of claim 6, further comprising:
receiving the message at the provider; and
obtaining the DRM permission in response to the identifier of the at least one segment encoded with the DRM technique.

8. The method of claim 7, further comprising:
forming a second message that includes the DRM permission for the at least one segment; and
transmitting the second message.

9. The method of claim 1, wherein the displaying of content further comprises displaying the content at a base resolution.

10. The method of claim 1, wherein the DRM permission allows the user to modify at least one image property.

10. (canceled)

11. An apparatus for managing content in a mobile device, the apparatus comprising:
a display configured to display image files;
a network interface configured to interface with a wireless network;
a digital rights management module configured to manage digital rights associated with received content, wherein the content comprises a plurality of segments; and
a controller configured to interface with the display, network interface, and the a DRM module, wherein the controller is also configured to determine DRM status of received content by using the DRM module, wherein the content comprises at least one file partitioned into plurality of tiles, to retrieve a DRM permission for at least one tile of the content being encoded by a DRM technique through the network interface, and to apply the DRM permission to the at least one tile of the content using the DRM module.

12. The apparatus according to claim 11, further comprising a memory configured to interface with the controller and to store the received content.

13. The apparatus according to claim 11, wherein the controller is configured to form a message requesting the DRM permission and transmitting the message through the network interface to a content provider.

14. The apparatus according to claim 11, wherein the DRM permission allows the user to modify at least one image property.

15. The apparatus according to claim 14, wherein the at least one image property includes one of resolution, brightness, contrast, region of interest, and bit-depth.

16. A method of providing content, the method comprising:
providing content to a plurality of users, wherein the content comprises of at least one file;
subdividing the at least one file into a plurality of sections;
applying at least one digital rights management encoding technique to at least one of the sections; and
packaging the at least one section encoded with the DRM technique and the unencoded sections of the plurality of sections as the content.

17. The method of claim 16, further comprising:
generating a plurality of permission keys, each key associated with a respective encoded section; and
storing the plurality of permission of keys.

18. The method of claim 17, further comprising:
receiving a message that requests a permission key for the at least one section encoded with the DRM technique;
retrieving the permission key; and
transmitting the permission key.

19. A method of managing content in a mobile device, the method comprising:
providing a plurality of segments associated with a file;
providing for a plurality of alternate segments, each alternate segment encoded with at least one digital rights management technique;
replacing at least one segment of the plurality of segments with an alternate segment; and
packaging the plurality of segments and alternate segments as content.

20. The method of claim 19, further comprising:
receiving content from a provider;
determining DRM status of each alternate segment of the plurality of alternate segments;
retrieving a DRM permission in response to the at least one alternate segment being encoded by a DRM technique;
applying the DRM permission to the at least one alternate segment; and
displaying the at least one alternate segment.

21. The method of claim 20, wherein the DRM permission is retrieved in response to the at least one alternate segment being encoded by a DRM technique is bundled with the content.

22. The method of claim 9, wherein the at least one image property includes one of resolution, brightness, contrast, region of interest, and bit-depth.
